(19) United States
(12) Patent Application Publication
(10) Pub. No.: US 2018/0147112 A1
(43) Pub. Date: May 31, 2018

(54) LIQUID CIRCULATION MEMBER FOR MASSAGE DEVICE

(71) Applicant: Cheng-Chuan Yang, Taichung City (TW)

(72) Inventor: Cheng-Chuan Yang, Taichung City (TW)

(21) Appl. No.: 15/364,276

(22) Filed: Nov. 30, 2016

(51) Int. Cl. A61H 23/00

(52) U.S. Cl. CPC A61H 23/00; A61H 2205/022; A61H 2205/12; A61H 2201/0214; A61H 2201/10; A61H 2201/01; A61H 2201/0207; A61H 2205/081

(57) ABSTRACT

A liquid circulation member for a massage device includes a body and a seal. The body has a room defined therein, and a path is formed at the inner bottom of the room. The seal is shaped to be matched with the body. The seal has a layer of glue spread on outside thereof so as to be connected to the body to seal the path. The seal has an inlet and an outlet to allow liquid to circulate via the path. Multiple vibration motors are connected to outside of the seal and located in the room of the body to massage the user's muscles.

### BACKGROUND OF THE INVENTION

### 1. Fields of the Invention

The present invention relates to a massage device, and more particularly, to a liquid circulation member for a massage device.

### 2. Descriptions of Related Art

There are different types of massage devices in the market, and some of which are complicated, bulky and expensive, and some have poor massage functions. Most of the conventional massage devices use mechanical way to provide massage features, such as motors and links to physically massage the user's muscles. Some of the conventional massage devices use hot or cold water to use temperature to let the user feel pain relief.

The present invention intends to provide a liquid circulation member for a massage device and the liquid circulation member allows liquid to circulate within the massage device to provide massage features to the users.

### SUMMARY OF THE INVENTION

The present invention relates to a liquid circulation member for a massage device, and comprises a body and a seal. The body has a room defined therein and a path is formed at the inner bottom of the room. The seal is shaped to be matched with the body and has a layer of glue spread on an outside thereof so as to be connected to the body to seal the path.

Preferably, the path is defined between two sidewalls, and each sidewall has a stepped portion on two sides thereof. The seal has a protrusion formed along each of two edges thereof, and the protrusions are glued to the stepped portions when the seal is connected to the body. The top of the seal is lower than the top of each of the sidewalls.

Preferably, the seal has an inlet and an outlet.

Preferably, multiple vibration motors are connected to outside of the seal and located in the room of the body.

Preferably, the body and the seal are made of silicon or Poly Vinyl Chloride (PVC).

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the liquid circulation member of the present invention;

FIG. 2 is a perspective view to show the liquid circulation member of the present invention;

FIG. 3 is another perspective view to show the liquid circulation member of the present invention;

FIG. 4 is a cross sectional view, taken along line IV-IV in FIG. 2;

FIG. 5 is an enlarged view to show that the seal is glued to the stepped portions of the path;

FIG. 6 shows that liquid circulates within the path of the liquid circulation member of the present invention;

FIG. 7 shows that vibration motors are connected to the seal of the liquid circulation member of the present invention;

FIG. 8 shows that the massage device is used on a user's face;

FIG. 9 shows that the massage device is used on a user's back, and

FIG. 10 shows that the massage device is used on a user's foot.

### DETAILED DESCRIPTION OF THE PREFERRED EMBODIMENT

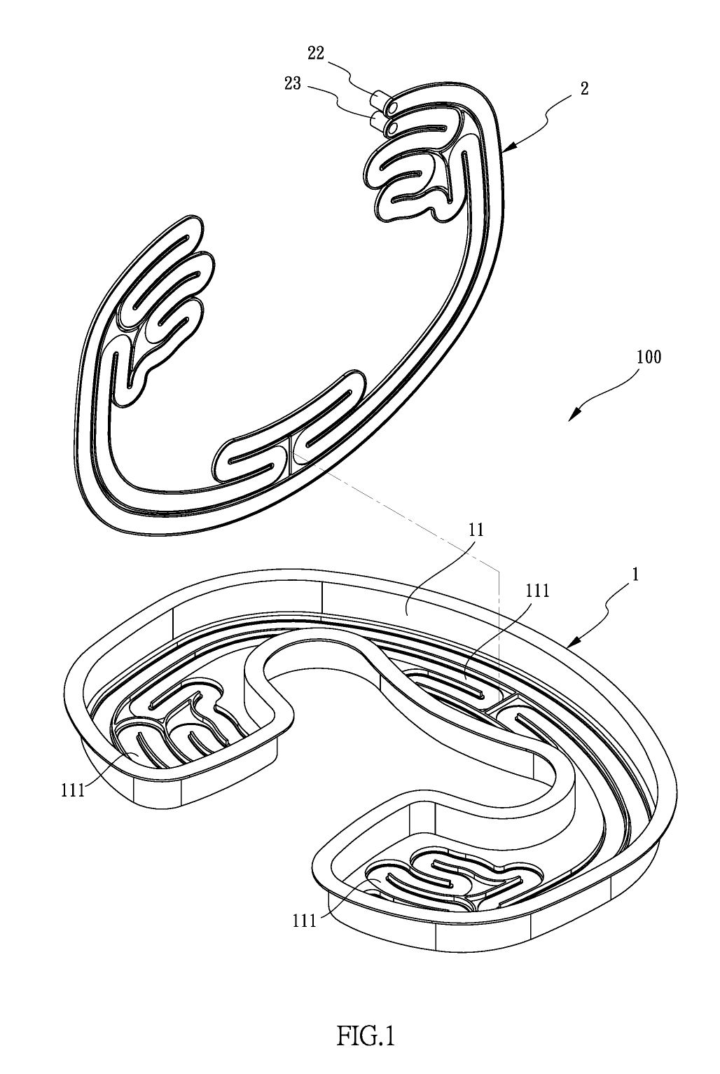

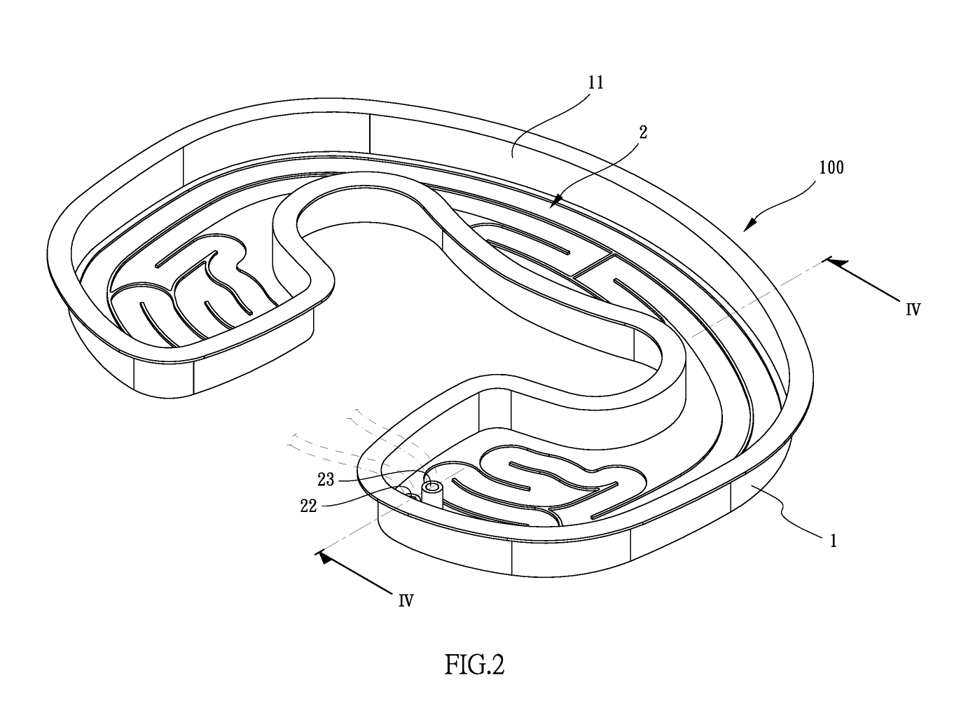

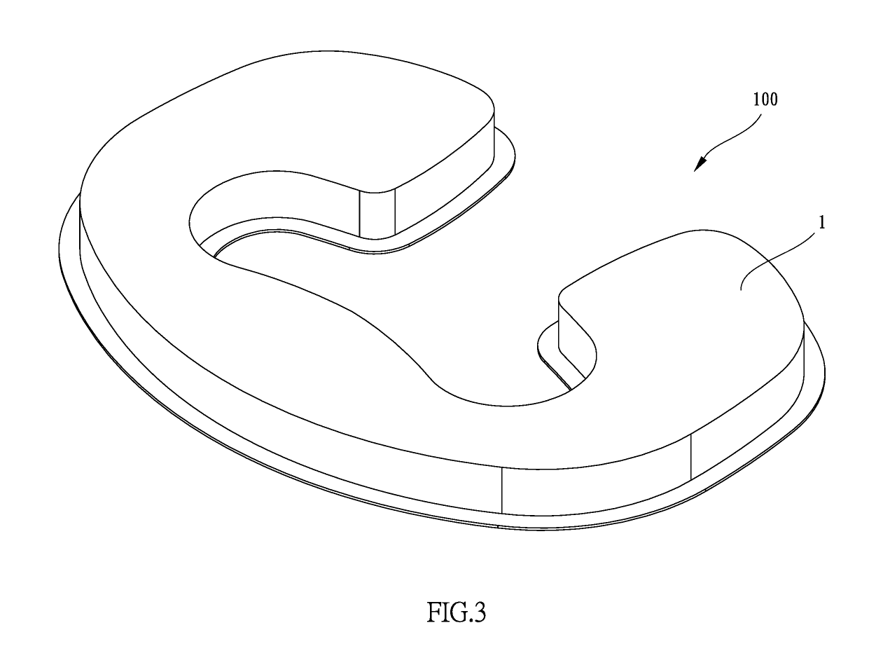

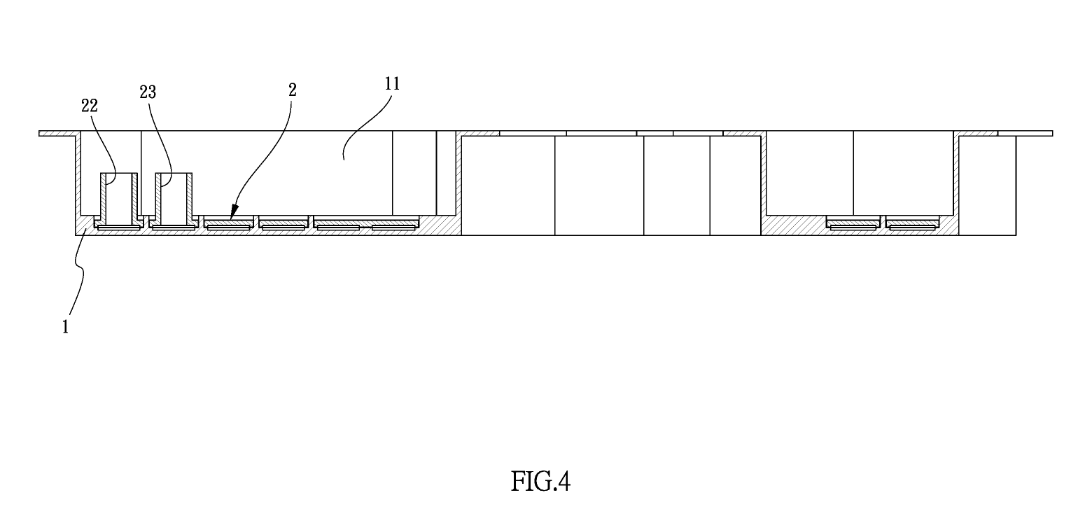

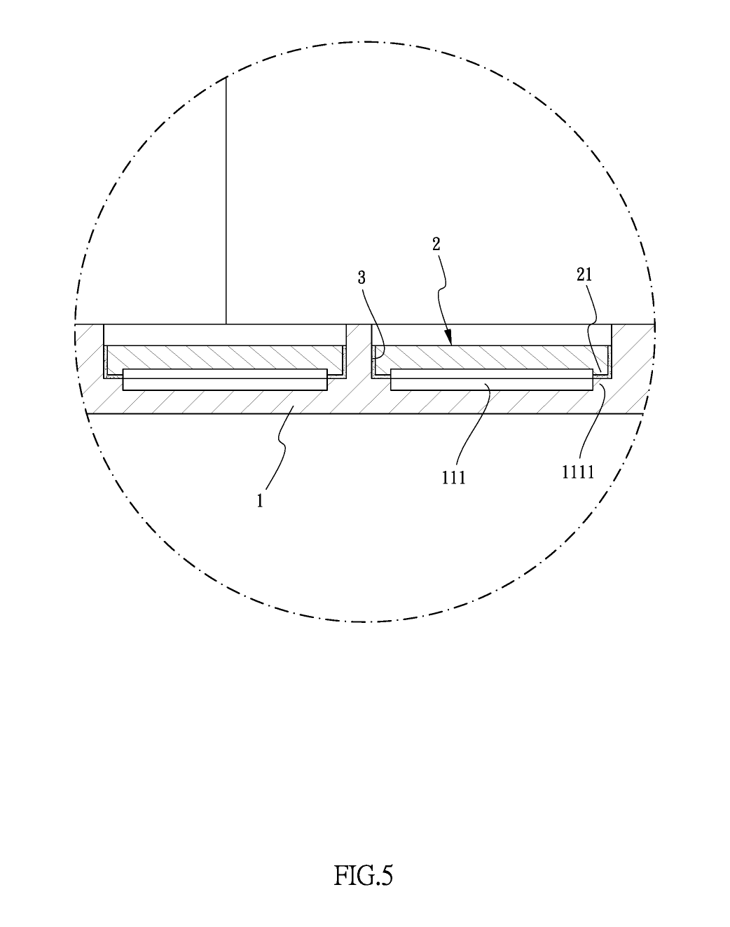

Referring to FIGS. 1 to 5, the liquid circulation member 100 for a massage device of the present invention comprises a body 1 and a seal 2. The body 1 has a room 11 defined therein and a path 111 is formed at the inner bottom of the room 11. The seal 2 is shaped to be matched with the body 1. A layer of glue 3 is spread on outside of the seal 2 so as to fix the seal 2 to the body 1 to seal the path 111.

Specifically, the path 111 is defined between two sidewalls, and each sidewall has a stepped portion 1111 on two sides thereof. The seal 2 has a protrusion 21 formed long each of two edges thereof. The protrusions 21 are glued to the stepped portions 111 when the seal 2 is connected to the body 1. The top of the seal 2 is lower than the top of each of the sidewalls. The seal 2 has an inlet 22 and an outlet 23 to introduce liquid from a liquid source (not shown) outside of the massage device into the path 111 and the liquid exits from the path 111 from the outlet 23.

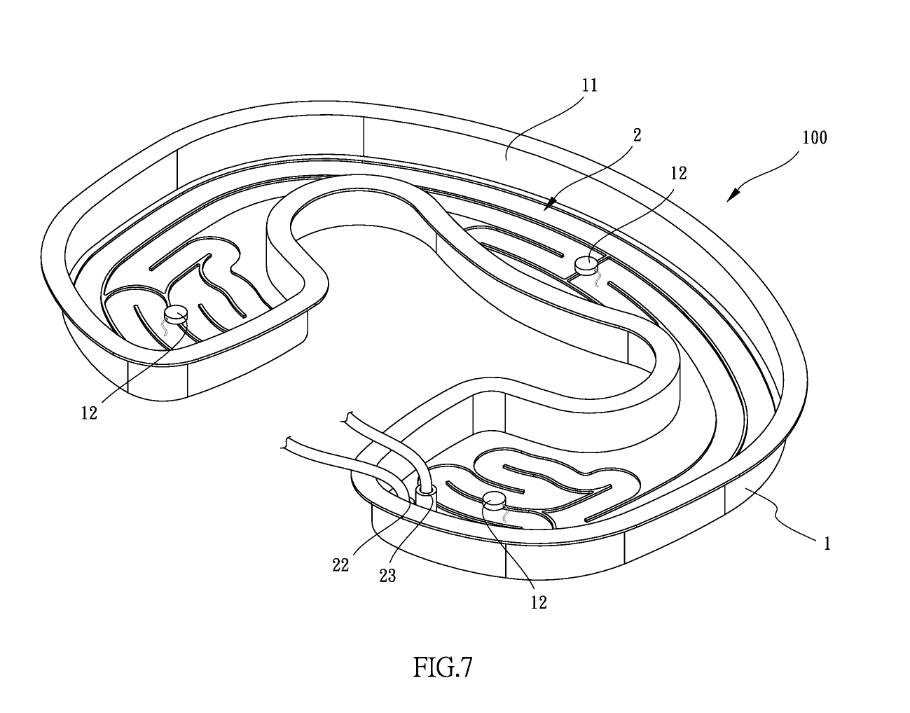

As shown in FIG. 7, multiple vibration motors 12 are connected to outside of the seal 2 and located in the room 11 of the body 1. The vibration motors 12 provide massage feature to the user's muscles.

Besides, the body 1 and the seal 2 are made of silicon or Poly Vinyl Chloride (PVC), both of which are soft to make the users feel comfortable when using the massage device of the present invention.

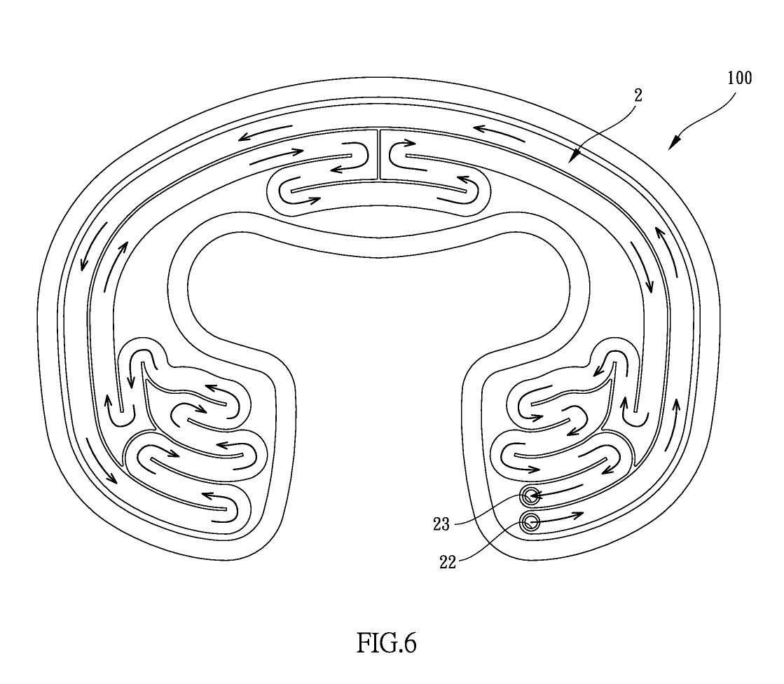

As shown in FIG. 6, the path 111 is formed to increase the length thereof so that path the liquid can move within the path 111 in the room 11 and provide desired temperature to the user at larger area.

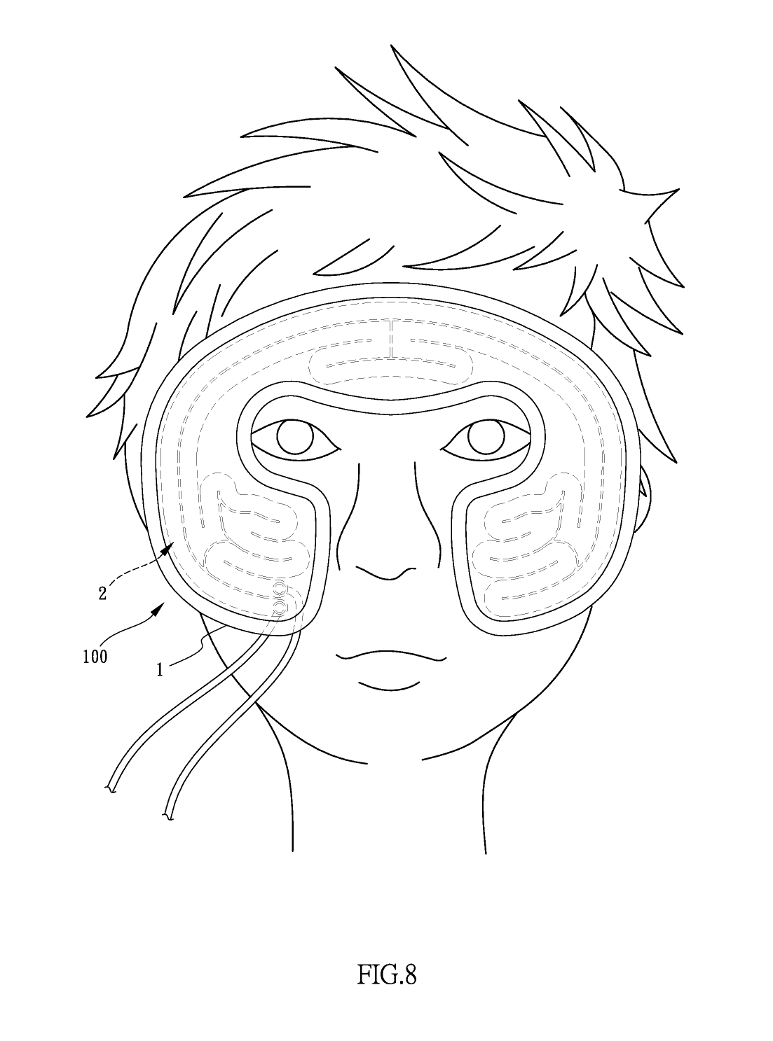

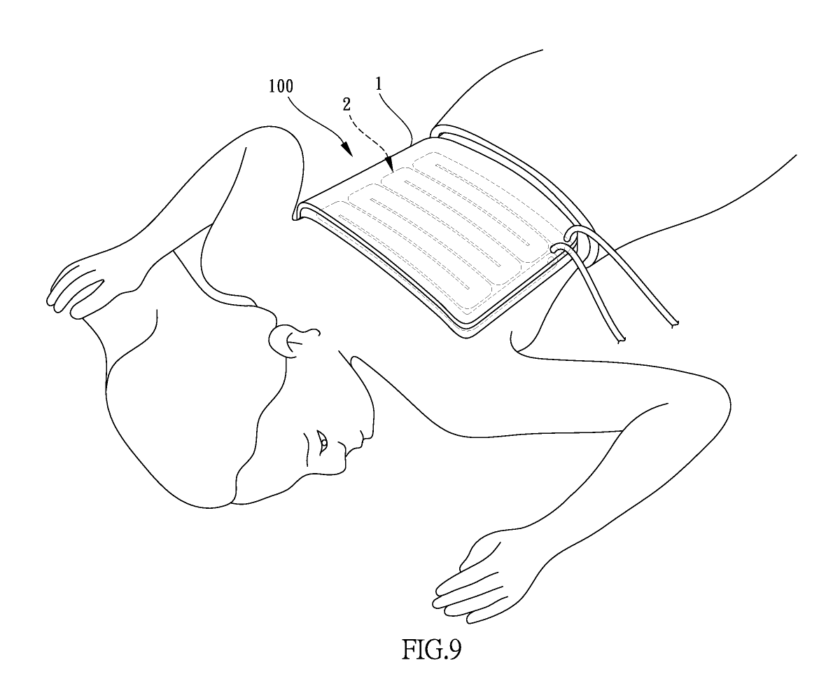

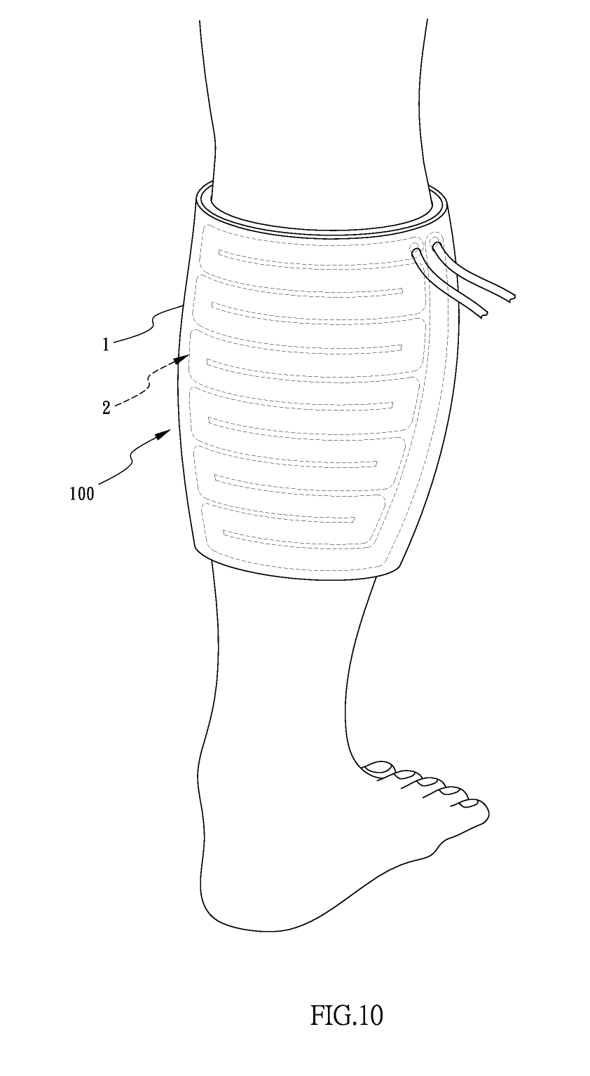

FIGS. 8 to 11 show that the massage device with the liquid circulation member 100 is used on the user's face, back and foot.

While we have shown and described the embodiment in accordance with the present invention, it should be clear to those skilled in the art that further embodiments may be made without departing from the scope of the present invention.

What is claimed is:

1. A liquid circulation member for a massage device, comprising:
a body 1 having a room defined therein and a path formed at an inner bottom of the room, and
a seal being shaped to be matched with the body, the seal having a layer of glue spread on an outside thereof so as to be connected to the body to seal the path.

2. The liquid circulation member as claimed in claim 1, wherein the path is defined between two sidewalls, each sidewall has a stepped portion on two sides thereof, the seal has a protrusion formed along each of two edges thereof, the protrusions are glued to the stepped portions when the seal is connected to the body, a top of the seal is lower than a top of each of the sidewalls.

3. The liquid circulation member as claimed in claim 1, wherein the seal has an inlet and an outlet.

4. The liquid circulation member as claimed in claim 2, wherein the seal has an inlet and an outlet.

5. The liquid circulation member as claimed claim 1 further comprising multiple vibration motors connected to outside of the seal and located in the room of the body.

6. The liquid circulation member as claimed in claim 1, wherein the body and the seal are made of silicon or Poly Vinyl Chloride (PVC).

7. The liquid circulation member as claimed in claim 5, wherein the body and the seal are made of silicon or Poly Vinyl Chloride (PVC).
